(19) United States
(12) Patent Application Publication
(10) Pub. No.: US 2009/0263314 A1
(43) Pub. Date: Oct. 22, 2009

(54) METHOD FOR PRODUCING CATALYST FOR WASTEWATER TREATMENT

(75) Inventors: JEN-CHIEH CHUNG, Taoyuan County (TW); SHU-MIN SHIH, Taoyuan County (TW); YU-SHENG CHEN, Taoyuan County (TW)

Correspondence Address: WPAT, PC, 7225 BEVERLY ST., ANNANDALE, VA, 22003, US

(73) Assignee: Institute of Nuclear Energy Research Atomic Energy Council, Executive Yuan, Taoyuan County (TW)

(21) Appl. No.: 12/169,009

(22) Filed: Jul. 8, 2008

(30) Foreign Application Priority Data
Apr. 22, 2008 (TW) 097114577

(51) Int. Cl. C01G 23/08; B05D 3/02

(52) U.S. Cl. 423/610; 427/226

(57) ABSTRACT

The present invention provides a method for producing catalyst for wastewater treatment, which comprising mixing polymers and additives, reacting with a titanate precursor, and then subjecting the resultant product to hydrolysis and condensation to form catalyst slurry. Due to using the titanate as a source of metal ions and the polymer compound as a dispersant and stabilizer, the aggregation between particles can be habited, and due to using additives as chelating agent and catalyst, it can improve solution stability and inhibit the oxidation of the metal, thereby facilitate the condensation and hydrolysis and shorten the reaction time. The catalyst slurry prepared by the method of the present invention exhibits excellent dispersibility to effectively contact with and decompose organics, such as those containing in wastewater and thus is suitable for wastewater treatment. In addition, the resultant catalyst slurry can be processed in the form of powder or film for using in industrial wastewater treatment.

### FIELD OF THE INVENTION

The present invention relates to a method for producing catalyst, especially to a method for producing catalyst for wastewater treatment.

### BACKGROUND OF THE INVENTION

Titania have been used widely in various industries fields including, for example, pigment, paper-making, paint, catalyst, sterilizing, cleaning, primer, wastewater treatment, decomposition of organic waste, etc. Recently, titania has been increasingly applied in high technology due to its unique semi-conductive properties. Titania is n-type semi-conductor and its molecular structure belongs to zinc blende lattice. According to crystal structure, titania can be classified into three major types, i.e. anatase, rutile and brookite.

Generally, the crystal structure of titania is in an amorphous state at ambient temperature, in anatase type when calcined at a temperature from 200° C. to 500° C., in rutile type when calcined at a temperature from 500° C. to 600° C., and in brookite type when calcined at a temperature above 700° C. Crystal structure of anatase and rutile would change with temperature changing so that they are usually used in photo-catalysis reaction. Among them, for stability rutile is the best and for photo-reactivity anatase is the best. Thus, in various industries applications, anatase is the popular starting material. Due to the excellent photo-catalytic activity of titania, its band gap for valence band and conduction band is up to 3.0 to 3.2 eV. When titania is irradiated by light having energy more than the band gap, it will result in separation of electron-hole pair, and the separated electron and hole will in turn recombine. The separation and recombination of the electron-hole pair are counter mechanisms each other, thus electron and hole can exhibit their photo-catalytic activity only in the case that the electron-hole pair is separated into electron and hole and each of themselves subjects to free radical reaction.

From the past investigation on titania, it knows that the surface properties including particle size, porosity, particle structure and morphology of titania will vary depending on its preparation. Such surface properties will affect the photo-catalytic activity of titania, which will in turn affect its catalytic efficiency directly. For example, when titania is applied in treating wastewater, such surface properties will affect its ability for decomposing organic ingredients when using in wastewater treatment and affect its electron transferring effect when using in film electrode of dye sensitized solar cell.

Recently, nanometer titania powder has been widely used in various industries and its demanded amount is increasing greatly. Therefore various processes for producing nanometer titania powder have been continuously developed so that the cost for obtaining nanometer titania powder from commercial source (for example P25 titania from Degussa) is greatly decreasing. However, since nanometer titania powder is very fine, if it is used for treating aqueous system to decompose the organics contained therein, the nanometer titania powder is difficultly separated from the aqueous system when the treatment is completed. To resolve this problem, a process comprising formulating a titania slurry, coating the slurry on a substrate to prepare a titania film is proposed.

The decomposition technology conventionally used in treating organic contaminates includes bio-treatment and incineration. However, the treating time for the bio-treatment is long and is difficult to treat high concentration contaminates. As to incineration, it is critically regulated not to generate toxic substances such as dioxins and furans during its operation. With advancing scientific technology, it is known that oxidation has a comparable decomposing ability on organic contaminates. For example, water quality can be purified by using air diffusing or various oxidizing agent to oxide the contaminants contained in water. However, addition of various chemicals will result in secondary environmental contamination. To resolve the existing problems, several chemical oxidizing technologies are developing. Among them, an advanced oxidation process (referred to AOP) is most popular. The mechanical of the AOP mainly uses the generated free radical OH. as the reaction substrate, since the oxidizing potential of the free radical OH. is 2.8 eV, which is the strongest oxidizing agent in addition to fluoride ion. The free radical OH. is the best choice for the oxidizing agent since fluoride ion is corrosive and thus its use is limited. When a solution contains free radical OH., it will subject to oxidization to decompose the organic contaminants contained therein. The free radical OH. not only withdraws chlorine atom from compounds but also destroy C—C double bond in the structure. The oxidization induced by free radical OH always decomposes organic contaminants into CO₂, H₂O, and other low molecular material (such as acid or simple hydrocarbon compounds). Based on the mechanism of the AOP, several combination processes have been developed including a combination of UV/H₂O₂/Fe²⁺, UV/O₃, UV/H₂O₂, O₃/H₂O₂, UV/H₂O₂/Fe²⁺/O₃ and the like. Improving the reaction effect of AOP by using photo-catalyst is aggressively developing recently. Therefore, how to prepare high reactive photo-catalyst is the major project.

There are usually two processes for making nanometer titania powder. The first one is a liquid phase synthesis and the second one is a gas phase synthesis. The liquid phase synthesis is further classified into the following four subclasses: (1) sol-gel which comprises dissolving high purity metal alkoxide (M(OR)ₙ) or metal salt in a solvent such as water or alcohol and carrying out hydrolysis and condensation to form a gel having some spatial structure; (2) hydrolysis which comprises forcing hydrolysis of metal salt in solvents of different pH value to obtain a homogeneous dispersion of nanometer titania particles; (3) hydrothermal process which comprises reacting titania precursor in a sealed stainless container at a specified temperature and a specified pressure to obtain nanometer titania particles; (4) micro-emulsion process which comprises adding titania precursor into micro emulsion consisting of water and surfactant and reacting to form mono-dispersion of nanometer micell and then drying and calcining the resultant mono-dispersion.

The gas phase synthesis for preparing titania powder can be classified into the following subclasses: (1) chemical vapor deposition which comprises subjecting a titania precursor and oxygen to chemical vapor deposition in a low pressure chemical vapor deposition device to form a titania film or powder; (2) flame synthesis which comprises stream-heating metal compound by hydrogen-oxygen flame or acetylene-oxygen flame to induce chemical reaction and form nanometer particles; (3) vapor condensation which comprises vaporizing the starting material through vaporization under vacuum, heating or high frequency induction into gaseous or fine particles and then quickly chilling to collect the resultant nanometer powder; (4) laser ablation which comprises vaporizing a metal or non-metal target by using high energy laser beam and condensing the stream to obtain stable atom clusters from the gaseous phase.

### SUMMARY OF THE INVENTION

The present invention provides a method for producing catalyst used in wastewater treatment, which is characterized by using a solution of titanate salts such as tetra-isopropyl orthotitanate in acetylacetone as titanium ion source, using hydroxyamines compounds such as hydroxylamine hydrochloride as a reducing agent, and using polymer as both a dispersing agent and stabilizer such as polyvinyl alcohol to prevent from the aggregation among particles and to generate porosity on particle surface. The present method is further characterized by adding suitable thiol compound such as 1-thioglycerol as a complexing agent for complexing metal and as a catalyst for enhancing efficiency of hydrolysis-condensation and thus shorten the synthesis time for synthesizing nanometer titania photo-catalyst. The nanometer titania photo-catalyst prepared by the present method has a high porosity, high specific surface area, and excellent light-absorbance and is suitable as photo-catalyst so that it can effectively enhance the degradation of organic substance when using in water treatment.

The present invention provides a method for producing catalyst used in wastewater treatment, which is characterized by using a solution of titanate salts such as tetra-isopropyl orthotitanate in acetylacetone as titanium ion source, using hydroxyamines compounds such as hydroxylamine hydrochloride as a reducing agent, and using polymer as both dispersing agent and stabilizer to prepare a titania slurry. Then the titania slurry is coated on a substrate to form a fine and transparent nanometer titania film. The film-coated substrate is suitable used for treating wastewater to decompose the organic substance contained therein. Moreover, since the photo-catalyst is formed as a film coated on a substrate, it is easily recovered from wastewater and recycled to use in next treatment so that the cost for wastewater treatment will be decreased.

The present invention provides a method for producing catalyst used in wastewater treatment, which is characterized by using a solution of titanate salts such as tetra-isopropyl orthotitanate in acetylacetone as titanium ion source, using hydroxyamines compounds such as hydroxylamine hydrochloride as reducing agent, and using polymer as both dispersing agent and stabilizer to prepare a titania slurry. Then the titania slurry is mixed with commercial available titania powder and added with proper amount metal oxide (such as Nb₂O₅, Ta₂O₅ etc.) to formulate a mixture slurry and the resultant mixture slurry is coated on a substrate to form a fine and transparent nanometer titania film.

In one embodiment, the present invention provides a method for producing catalyst used in wastewater treatment, which comprises the following steps: a) preparing a solution containing a polymer and a hydroxylamine compound; b) preparing a titanate solution; c) mixing the solution in step a) and the titanate solution in step b) to form a first mixture; d) adding a thiol compound into the first mixture in step c) to form a second mixture; and e) allowing the second mixture to react to form a viscose catalyst slurry.

The method for producing catalyst used in wastewater treatment according to the present invention preferably further comprises steps of: drying the viscose catalyst slurry; grinding it into powder; and calcining the resultant powder to form titania powder in crystal form.

In one embodiment, the present invention further provides a method for producing catalyst used in wastewater treatment, which comprises the following steps: a) preparing a solution containing a polymer and a hydroxylamine compound; b) preparing a titanate solution; c) mixing the solution in step a) and the titanate solution in step b) to form a first mixture; d) adding a thiol compound into the first mixture in step c) to form a second mixture; e) allowing the second mixture to react to form a first viscose catalyst slurry; f) dissolving the first viscose catalyst slurry in an alcohol solvent to formulate a second catalyst slurry; and g) coating the second catalyst slurry on a substrate and heating the slurry to form a catalyst film on the substrate.

In one embodiment, the present invention also provides a method for producing catalyst used in wastewater treatment, which comprises the following steps: a) preparing a solution containing a polymer and a hydroxylamine compound; b) preparing a titanate solution; c) mixing the solution in step a) and the titanate solution in step b) to form a first mixture; d) adding a thiol compound into the first mixture in step c) to form a second mixture; e) allowing the second mixture to react to form a first viscose catalyst slurry; f) mixing the first viscose catalyst mixture and titania powder at a certain ratio to form a second catalyst slurry; g) mixing the second catalyst slurry with at least one metal oxide to form a third catalyst slurry; and h) coating the third catalyst slurry on a substrate and heating the slurry to form a catalyst film on the substrate.

### BRIEF DESCRIPTION OF THE DRAWINGS

FIG. 1A is a flow chart showing the method for producing catalyst used in wastewater treatment according to the first embodiment of the present invention;

FIG. 1B is a flow chart showing additional procedures for Step 24;

FIG. 2A is a flow chart showing the method for producing catalyst used in wastewater treatment according to the second embodiment of the present invention;

FIG. 2B is a flow chart showing additional procedures for processing the slurry into powder;

FIG. 3 is a curve graph showing the relationship between I³⁻ formation rate in terms of UV absorbance vs. time;

FIG. 4A is a flow chart showing the method for producing catalyst used in wastewater treatment according to the third embodiment of the present invention;

FIG. 4B is a flow chart showing additional procedures for heating treatment in the third embodiment; and

FIG. 5 is a flow chart showing the method for producing catalyst used in wastewater treatment according to the fourth embodiment of the present invention.

### DETAILED DESCRIPTION OF THE INVENTION

The present invention is illustrated in detail by the following Examples by reference to the accompanied drawings. But the present invention is not limited to the Examples.

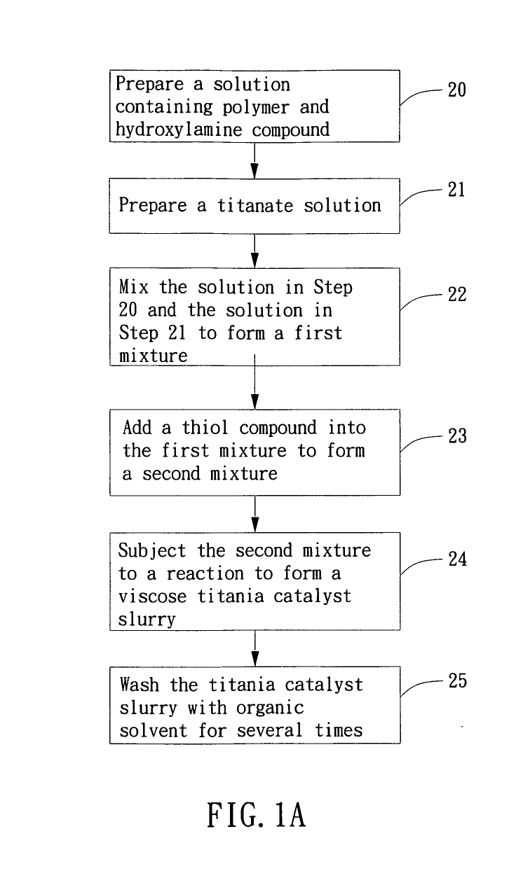

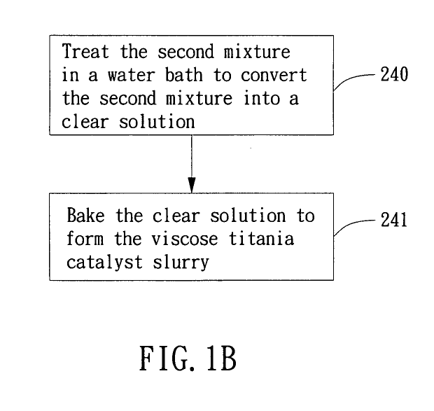

FIG. 1A is a flow chart showing the method for producing catalyst used in wastewater treatment according to the first embodiment of the present invention. The first embodiment of the method for producing catalyst used in wastewater treatment comprises the following steps. Step 20: prepare a solution containing a polymer and a hydroxylamine, wherein the polymer is used as both a dispersing agent and a stabilizer and the hydroxylamine such as hydroxylamine hydrochloride or LAHC (laurylamine hydrochloride) is used as a reducing agent. The polymer can be, for example, polyvinyl alcohol pr polyvinylpyrrolidone. The polymer is not limited to the above examples and it can be any polymer as long it functions as a dispersing agent and a stabilizer and can be used for preventing the particles from aggregation and for generating porosity on the surface of the particles.

Step 21: prepare a titanate solution. In this step, the titanate solution is a solution of tetra-isopropyl orthotitanate in acetylacetone as titanium source. Step 22: mix the titanate solution from Step 21 with the hydroxylamine solution from Step 20 to form a first mixture. After mixing thoroughly, subject to step 23: add a thiol compound into the first mixture and stir evenly to form a second mixture. In Step 23, the thiol compound is used as both complexing agent and catalyst, which can enhance the stability and prevent the metal ion from being oxidized so that it facilitates hydrolysis and condensation and shorten reaction time. In this embodiment, the thiol compound is 1-thioglycerol but is not limited thereto.

Step 24: subject the second mixture to a reaction to form a viscose titania catalyst slurry. Please refer to FIG. 1B, FIG. 1B is a flow chart showing additional procedures for the Step 24. Step 24 further comprises Step 240 and Step 241. Step 240 comprises treating the second mixture in a water bath to convert into a clear solution and Step 241 comprises baking the clear solution to form the viscose titania catalyst slurry. The baking is carried out by placing the clear solution in an oven for an appropriate time. Please refer back to FIG. 1A, then Step 25 is carried out. Step 25 comprises washing the viscose titania catalyst slurry with an organic solvent for several times to remove un-reacted substance. In this embodiment, the organic solvent is isopropanol, but is not limited thereto.

Next, the method for preparing catalyst slurry is illustrated by an Example.

### EXAMPLE 1

2.2 Grams of hydroxyamines such as hydroxylamine hydrochloride were dissolved in distilled water completely and 1 gram polymer such as polyvinylpyrrolidone was added into the hydroxylamine solution and stirred to dissolve the polymer completely. Then distilled water was added to make the volume to be 100 ml. 10 ml tetra-isopropyl orthotitanate and 3.5 ml were mixed and added into 85 ml of the hydrxyamine hydrochoride/polyvinylpyrrolidine solution. After stirring, 0.5 ml thiol compound such as 1-thioglycerol was added therein and stirred for 30 minutes. The resultant solution was placed in a water bath at a constant temperature of 40° C. for 24 hours. The resultant solution was transferred into a 100 ml sealable flask and the flask was sealed and placed into an oven at a temperature of 80° C. for 2-6 days, preferably for 3-4 days. Then the flask was taken out from the oven and cooled to room temperature, in that time, the solution contained in the flask was converted into white flowable slurry from yellow solution. The slurry was washed with isopropanol for several times to remove un-reacted substance and obtain a titania slurry. The particle size of the titania contained in the slurry was measured as from 10 to 50 nm, its average particle size was 20 nm, crystal structure was anatase, and specific surface area was 40 to 60 m²/g.

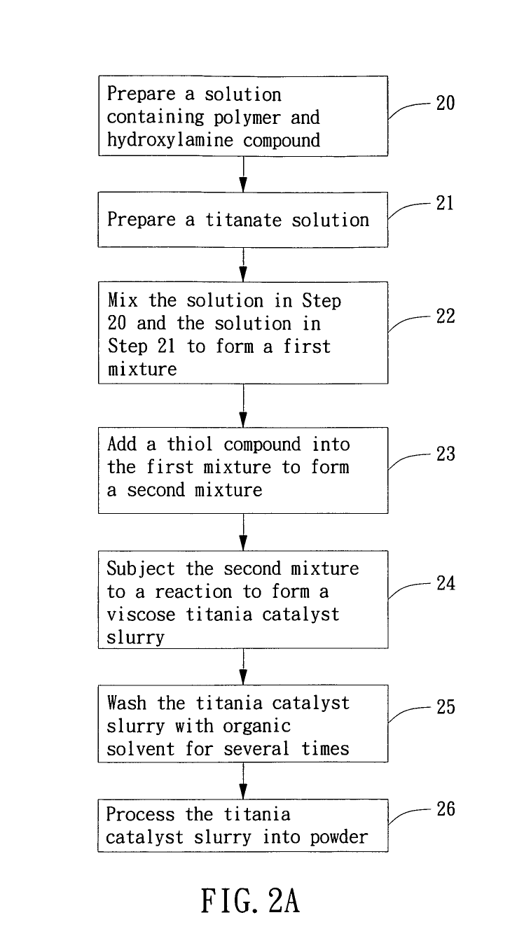

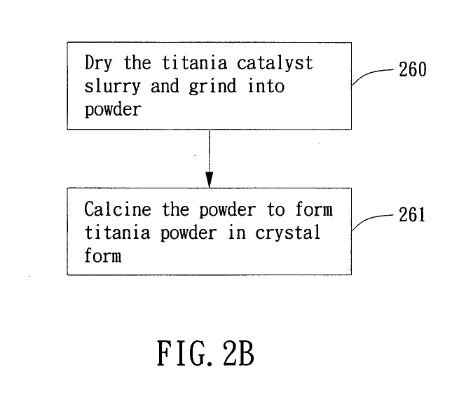

FIG. 2A is a flow chart showing the method for producing catalyst used in wastewater treatment according to the second embodiment of the present invention. This embodiment is substantial similar to FIG. 1A except that this embodiment further comprises a Step 26 for processing the titania slurry into titania powder. Please refer to FIG. 2B. FIG. 2B is a flow chart showing additional procedures for processing the titania slurry into titania powder. The Step 26 for processing the titania slurry into titania powder further comprises a Step 260 for drying the titania slurry and grinding into titania powder and Step 261 for calcining the titania powder to form titania powder in crystal structure. In the Step 260, the drying can be carried out by drying in air or in an oven. In this embodiment, the titania slurry was placed in an oven at a temperature of 60° C. and dried. In the Step 261, the calcining was carried out by placing the titania powder from Step 260 into a furnace at a temperature of from 350˜400° C. and calcined for 2 hours to form titania powder having crystal morphology. The titania powder produced in Step 261 exhibits high porosity, high specific surface area and excellent light absorbance and is suitable used as photo-catalyst. The titania powder of the present invention thus can enhance the effect for decomposing the organic substance contained in wastewater when using in wastewater treatment.

Next, the method for preparing titania powder is illustrated by the following Example.

### EXAMPLE 2

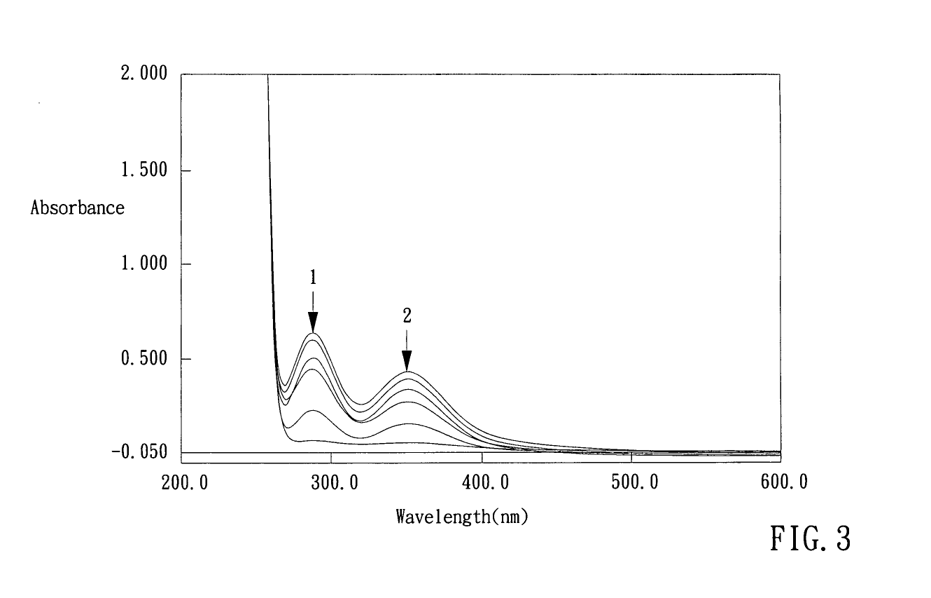

The titania slurry prepared from Example 1 was washed with isopropanol to remove un-reacted substances and dried in air (or in an oven at a temperature of 40 to 80° C.). After drying, the titania was placed in a mortar to be ground into powder. Then the ground powder was placed in a furnace at a temperature of 400° C. and calcined for 2 hours and cooled to room temperature. The average particle size of the titania powder was measured as from 50 to 250 nm. 0.05 g of the titania powder was added with 50 ml of 0.2M aqueous potassium iodide (KI) solution and shaken by ultra sonicator in dark for 5 minutes to disperse the titania powder in the aqueous solution evenly. At that time, the resultant titania dispersion was sampled and measured the concentration as a standard concentration before reaction. The titania dispersion was stirred for 5 minutes and then subjected to photo-chemical reaction by irradiating with mercury lamp at a light power of 500 W in a distance of 11 cm above the dispersion while the reaction was shield with a stainless housing to prevent from interfering with external light. The reaction solution was sampled at 15, 30, 60, 90, and 120 minutes, respectively, and filtered by syringe filter or high speed centrifuge to remove titania powder dispersed therein. The upper layer was measured its absorbance variation at 288 nm by using Ultraviolet Absorption Spectrophotometer. In the titania/KI dispersion, titania was irradiated to oxide I⁻ ion in the solution and the I⁻ ion was further reacted to form I³⁻. The absorbance intensity change of I³⁻ at wavelength 288 nm in UV absorption spectrum was measured to determine the photo-catalytic activity of titania. FIG. 3 shows a graph of absorbance intensity of I³⁻ vs. wavelength. It showed that the concentration of I³⁻ increased with the increasing of irradiation time and its absorbance intensity at 288 nm in the UV absorption spectrum also increased. It clearly demonstrated that the titania prepared by the present method exhibited excellent photo-catalytic activity.

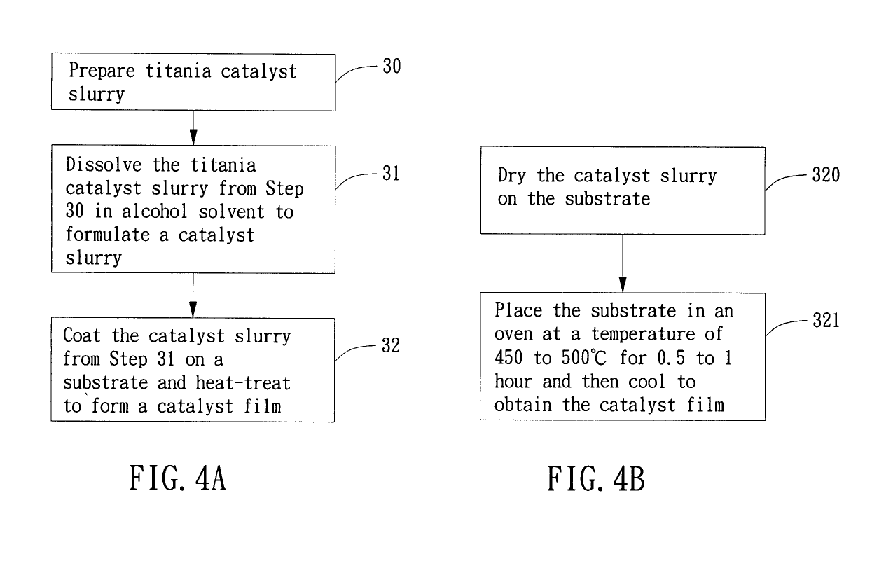

Please refer to FIG. 4A, which is a flow chart showing the method for producing catalyst used in wastewater treatment according to the third embodiment of the present invention. In this embodiment, the present method comprises the following steps: Step 30 for preparing titania catalyst slurry which can follow the procedures shown in FIG. 1A; Step 31 for dissolving the titania catalyst slurry from Step 30 in an alcohol solvent to formulate a catalyst slurry. In the Step 31, the used alcohol solvent is an alkanol solvent having 1 to 5 carbon atoms, preferably ethanol and isopropanol, but it is not limited to those.

Then Step 32 is carried out for coating the catalyst slurry from Step 31 onto a substrate and subjecting to heating treatment to form a catalyst film. The substrate can be in a regular shape such as substrate in a plate, a sphere, a strand shape; or in un-regular shape. As to the method coating the slurry on the substrate, it includes a doctor coating method for coating the slurry on a plate substrate to form a catalyst film; or a dipping coating method for dipping a sphere, a strand, or un-regular substrate in the slurry. In other words, shape of substrate can be selected based on the final use and the coating method can also be selected based on the shape of substrate used, which is easily determined by those skilled in the art by reference to the disclosure of the present embodiments.

FIG. 4B is a flow chart showing additional procedures of heating treatment. The heating treatment comprises the following steps: Step 320 for drying the catalyst slurry coated on the substrate. The drying can be carried out in the air. Then Step 321 is carried out for placing the substrate in a furnace with slowly increasing temperature to 450˜500° C. for 0.5 to 1 hour and then cooling to room temperature to form a catalyst film, i.e. titania catalyst film having a thickness of about 1-6 μm. The titania catalyst film exhibits excellent adhesion on the substrate and has hardness of up to 6H order determined by Pencil Test. The titania catalyst film can be used as a photo-catalyst material in a photochemical reaction, for example, in wastewater treatment to decompose the organic material contained in the wastewater. Moreover, since the titania catalyst is formed in a film adhered on a substrate, it is easily recycled and re-sued in next application and thus the treatment cost can be lowered.

Next, the method for preparing titania powder is illustrated by the following Example.

### EXAMPLE 3

### Preparation of Nanometer Titania Catalyst Film

The titania catalyst slurry prepared from Example 1 was coated on a FTO conductive glass substrate with a doctor coating method and then the substrate was placed in room temperature and dried in the air for at least 3 to 8 hours, preferable 5 hours. The substrate was then placed into a furnace at a temperature of 450˜500° C. for 0.5 to 1 hour and then cooled to room temperature to form a fine transparent titania film on the FTO conductive glass substrate. The titania film exhibited excellent adhesion to the substrate and the titania film had a thickness of from 1 to 5 μm, preferably 2 to 3 μm. In this embodiment, the polymer could be, for example, polyethylene oxide, polyacrylonitrile, polyvinyl alcohol, polyvinylpyrrolidone, polyvinyl acetate, carboxymethyl cellulose, polyethylene glycol, and the like. Moreover, in this embodiment, the hydroxylamine compound could also include laurylamine hydrochloride (LAHC) in addition to hydroxylamine hydrochloride. Also, the alcohol solvent used in this embodiment could be an alkanol solvent having 3 to 6 carbon atoms, preferably isopropanol.

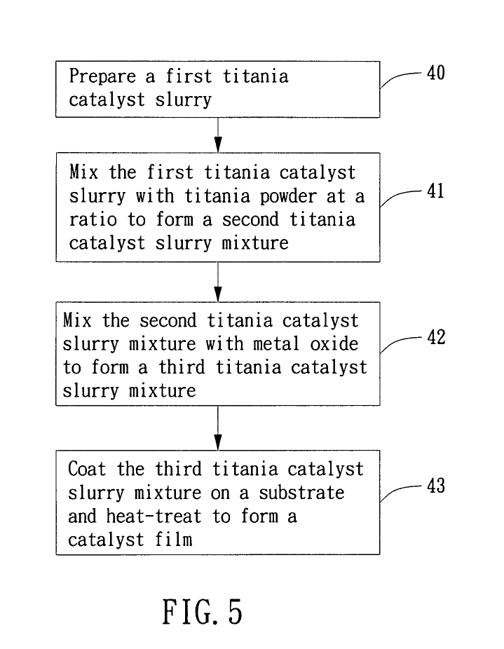

Please refer to FIG. 5, which shows a flow chart showing the method for producing catalyst used in wastewater treatment according to the fourth embodiment of the present invention. The method for producing catalyst in this embodiment comprises the following steps: Step 40 for providing a first titania catalyst mixture, which is similar to the procedure shown in FIG. 1A. Then Step 41 is carried out for mixing the first titania catalyst mixture with a titania powder at a certain ratio to form a second titania catalyst mixture. In Step 41, the titania powder can use any available commercial titania powder as long as it is nanometer order titania, for example, Degussa P25, ISK STS-01, Hombikat UV-100, and the like. As to solvent used in Step 41 and its amount, it can be easily determined by those skilled in the art depending on the kinds of available commercial titania powder and the titania slurry prepared by the present method and their amounts. It usually uses water as the solvent but is not limited to water.

In Step 41, the first titania catalyst mixture is mixed in an amount of 30 to 95% by weight, preferably from 60 to 90% by weight, with the available commercial titania powder to form a second titania catalyst mixture. Moreover, in Step 41, a minor binder can be added. Kinds of the binder and its amount are not limited and can be determined by those skilled in the art depending on the kinds of available commercial titania powder and the titania slurry prepared by the present method and their amounts. Examples of the binder include acetylacetone, polyethylene glycol having a molecular weight of from 400 to 50,000, Triton X-100, polyvinylalcohol (PVA), arabic gum powder, gelatin powder, polyvinylpyrrolidine (PVP), and styrene and the like. Among them, acetylacetone, polyethylene glycol having a molecular weight of from 400 to 50,000, and Triton X-100 are preferable.

Next Step 42 is carried out which comprises mixing the second titania catalyst mixture with at least one metal oxide to formulate a third titania catalyst mixture with a moderately viscosity. The metal oxide is selected from Nb₂O₅, Ta₂O₅, or a combination thereof. Finally, Step 43 is carried out which comprises coating the third titania catalyst mixture on a substrate and subjecting to a heating treatment to form a catalyst film. The substrate used in Step 43 is not limited, and can be a conductive substrate or others. Examples of the substrate include a ITO conduction glass, a FTO conductive glass, a fiber, a metal substrate and the like. The substrate can be in any shape, such as in form of plate, circular, or strand. The method for coating the mixture on the substrate can use any coating method as long as it can obtain a film having a desired thickness. For example, the coating can be wet coating process such as spin coating, doctor coating, dipping coating, and the like. The heating treatment comprises calcining the film at a temperature of from 450 to 500° C. for 0.5 to 1 hour, but it is not limited thereto. The heating conditions are easily determined by those skilled in the art based on the subject to be treated. The titania catalyst film prepared by the method of present invention has a thickness of from 5 to 40 μm, preferably from 10 to 20 μm; and a hardness of 2B to 6H determined by Pencil Test; and particle size of the particle contained in the film is in a range of from 5 to 100 nm, preferably from 15 to 50 nm.

Next, the method for preparing titania catalyst film is illustrated by the following Example.

### EXAMPLE 4

### Preparation of Nanometer Titania Slurry Mixture and Titania Catalyst Film

2 ml nanometer titania slurry prepared in Example 1 was added with 5 to 30 wt %, preferably 7 to 15 wt % of titania powder Degussa P25 and the resultant mixture was ground in a mortar for 10 to 20 minutes to form an evenly slurry solution. The slurry solution was then added with 1 to 10 wt %, preferably 2 to 6 wt % of Nb₂O₅ or Ta₂O₅ powder and ground for 10 to 20 minutes to form an evenly titania slurry mixture. The resultant titania slurry mixture was coated on a FTO conductive glass substrate by doctor coating method and dried in the air for at least 3 to 8 hours, preferably 5 hours, and then calcined in a furnace at a temperature of from 450 to 500□ for 0.5 to 1 hour and cooled to room temperature to form a titania film on the FTO conductive glass. The titania film exhibited excellent adhesion to the substrate and its particle size was measured to be found an average particle size of from 50 to 250 nm and its thickness was in a range of from 5 to 15 μm, preferably from 8 to 12 μm. Moreover, in this embodiment, the titania slurry mixture can be further added with a binder, such as acetylacetone, polyethylene glycol having a molecular weight of from 400 to 50000, Triton X-100, and the like, in an amount of from 0 to 3 wt %.

The comparison between the titania powder prepared in the present invention and the commercial available titania powder is illustrated by the following Example.

### EXAMPLE 5

A titania powder was prepared by the procedures mentioned in Example 1 except that LAHC (laurylamine hydrochloride) was used instead of hydroxylamine hydrochloride as the hydroxyamines compound and no polymers such as polyvinylpyrrolidone and 1-thioglycerol were added. The preparation was as follows: (a) 2.2 g LAHC was dissolved in 100 ml water; (b) 10 ml tetra-isopropyl orthotitanate was mixed with 3.52 ml acetylacetone and stirred thoroughly; (c) 85 ml solution prepared in the step (a) was added into the solution prepared in the step (b) and stirred for 30 minutes to form an evenly mixture solution; (d) the mixture solution prepared in the step (c) was placed in a water bath at a temperature of 40□ and reacted for at least 24 hours; (e) the solution prepared in the step (d) was transferred into a flask and sealed and then placed in an oven at a temperature of 80□ for further reacting for at least 5 days to form a light yellow flowable slurry. The flowable slurry was cooled and washed with isopropanol for several times to remove un-reacted material and then the isopropanol was evaporated. The residual slurry was dried in the air or in an oven at a temperature of from 40 to 80□ and ground into powder in a mortar. The resultant powder was calcined in a furnace at a temperature of 400□ for 2 hours and then cooled to room temperature to obtain a titania powder (referred to Powder A). The commercial available titania powder Degussa P 25 was referred to Powder B. The titania powder prepared from Examples 1 and 2 was referred to Powder C. Each 0.05 g of the Powder A, Powder B, and Powder C was added with 50 ml of 0.2M aqueous KI solution and subjected to the reactions and irradiation the same as in Example 2. The reaction was sampled to analysis its I³⁻ concentration. The result was summarized in Table 1. The ability of Powder A, Powder B and powder for forming I³⁻ was (C)>(B)>(A). In other words, the Powder C prepared by the present method exhibited the best photo-catalytic activity, which is higher than commercial available titania powder Degussa P25.

TABLE 1
The ability of Powder A, Powder B and powder for forming I³⁻.

| Irradiation Time | Concentration of I³⁻ (M) × 10⁻⁴ | | |
|---|---|---|---|
| (mins) | (A) | (B) | (C) |
| 0 | 0 | 0 | 0 |
| 15 | 0.041 | 0.057 | 0.058 |
| 30 | 0.077 | 0.064 | 0.112 |
| 60 | 0.093 | 0.103 | 0.127 |
| 90 | 0.107 | 0.138 | 0.150 |
| 120 | 0.137 | 0.158 | 0.162 |

ε: molar extinction coefficient = 4 × 10⁴ (cm mole)⁻¹

### EXAMPLE 6

### Preparation of Titania Film Prepared from the Present Method and from Commercial Available Titania Powder and Comparison of Their Light-Power Conversion Efficiency

The first titania mixture slurry was prepared as the same as Example 4 in which the titania powder Degussa P25 was in an amount of 7 wt % (Slurry A). Separately, a commercial available titania slurry Solaronic TiO2 was mixed with 7 wt % of titania powder Degussa P25 to prepare a second mixture slurry (Slurry B). Separately, 2 g of titania powder Degussa P25 was added with 10 μl acetylacetone, 50 μl Triton X-100, 4 ml distilled water and 0.8 g polyethylene glycol and ground in a mortar to form a slurry (Slurry C). Each of Slurry A, Slurry B, and Slurry C was evenly coated on a FTO conductive glass substrate and dried in the air for at least 3 to 8 hours, preferably 5 hours, and then placed in a furnace at a temperature of 450 to 500□ and calcined 0.5 to 1 hour to form a titania film on the FTO conductive glass substrate. After the resultant substrate was cooled to 80□, the substrate was immersed in 0.3 mM Ruthenium 533 dye solution for 2 hours and then dried to obtain a working electrode. The resultant working electrode was used as the anode, a platinum-plated FTO conductive glass substrate was used as the cathod, and an iodine-containing solution was used as electrolyte to constitute a cell. The cell was tested its light-power conversion efficiency (η) by using AM1.5 Solar simulator. The results are shown in Table 2. From Table 2, it clearly shows that the light-power conversion efficiency (η) of the working electrode prepared from the Slurry A was 5.30%, and Slurry B was 3.02%, and Slurry C was 4.27%. It demonstrated that the titania film prepared by the present invention exhibited the best light-power conversion efficiency.

TABLE 2
Comparison of light-power conversion efficiency between
the films prepared from present titania slurry and commercial
available titania powder

| | | | | light-power |
|---|---|---|---|---|
| | Photo | Photo | Filling | conversion |
| | Current | Voltage | Factor | efficiency |
| Film | I_{sc} (mA/cm²) | V_{oc} (V) | FF | (η) |
| The film prepared | 12.1 | 0.78 | 0.56 | 5.30% |
| from the present | | | | |
| titaniapowder + | | | | |
| Degussa P 25 (7%) | | | | |
| (Slurry A) | | | | |
| Film prepared from | 11.7 | 0.70 | 0.52 | 4.27% |
| Solaronic TiO₂ + | | | | |
| Degussa P 25 (7%) | | | | |
| (Slurry B) | | | | |
| Film prepared from | 9.3 | 0.72 | 0.45 | 3.02% |
| Degussa P 25 | | | | |
| (100%) | | | | |
| (Slurry C) | | | | |

While the present invention has been particularly shown and described with reference to exemplary embodiments thereof, it will be understood by those of ordinary skill in the art that various changes and modifications may be made therein without departing from the spirit and scope of the present invention as defined by the following claims.

What is claimed is:

1. A method for producing catalyst used in wastewater treatment, which comprises the following steps:
a) preparing a solution containing a polymer and a hydroxylamine compound, wherein the polymer is a dispersing agent and stabilizer, and the hydroxylamine is reducing agent;
b) preparing a titanate solution with titanate salts;
c) mixing the solution in step a) and the titanate solution in step b) to form a first mixture;
d) adding a thiol compound into the first mixture in step c) to form a second mixture, wherein the thiol is a complexing agent; and
e) allowing the second mixture to react to form a viscose catalyst slurry.

2. The method according to claim 1, wherein the hydroxylamine compound is hydroxylamine hydrochloride or laurylamine hydrochloride (LAHC).

3. The method according to claim 1, wherein the titanate solution is comprising of titanate compound and acetylacetone.

4. The method according to claim 3, wherein the titanate compound is tetra-isopropyl titanate.

5. The method according to claim 1, wherein the step e) further comprises the following steps:
e1) treating the second mixture in a water bath to convert the second mixture into clear solution; and
e2) baking the clear solution to form a viscose catalyst slurry.

6. The method according to claim 1, which further comprises a step of washing the catalyst slurry with organic solvent for several times after the step e).

7. The method according to claim 6, wherein the organic solvent is isopropanol.

8. The method according to claim 1, which further comprises a step of drying the catalyst slurry and grinding it into powder.

9. The method according to claim 8, which further comprises a step of calcining the powder to form titania powder in crystal form.

10. The method according to claim 1, wherein the polymer is polyvinylpyrrolidone.

11. A method for producing catalyst used in wastewater treatment, which comprises the following steps:
a) preparing a solution containing a polymer and a hydroxylamine compound, wherein the polymer is a dispersing agent and stabilizer, and the hydroxylamine is reducing agent;
b) preparing a titanate solution with titanate salts;
c) mixing the solution in step a) and the titanate solution in step b) to form a first mixture;
d) adding a thiol compound into the first mixture in step c) to form a second mixture, wherein the thiol is a complexing agent;
e) allowing the second mixture to react to form a first viscose catalyst slurry;
f) dissolving the first viscose catalyst slurry in an alcohol solvent to formulate a second catalyst slurry; and
g) coating the second catalyst slurry on a substrate and heating the slurry to form a catalyst film on the substrate.

12. The method according to claim 11, wherein the hydroxylamine compound is hydroxylamine hydrochloride or laurylamine hydrochloride (LAHC).

13. The method according to claim 11, wherein the titanate solution is comprising of titanate compound and acetylacetone.

14. The method according to claim 13, wherein the titanate compound is tetra-isopropyl titanate.

15. The method according to claim 11, wherein the step e) further comprises the following steps:
e1) treating the second mixture in a water bath to convert the second mixture into clear solution; and
e2) baking the clear solution to form the first viscose catalyst slurry.

16. The method according to claim 11, which further comprises a step of washing the first catalyst slurry with organic solvent for several times after the step e).

17. The method according to claim 16, wherein the organic solvent is isopropanol.

18. The method according to claim 11, wherein the polymer is polyvinylpyrrolidone.

19. The method according to claim 11, wherein the alcohol solvent is an alkanol solvent.

20. The method according to claim 11, wherein the heating in the step g) is carried out by the following steps:
g1) drying the second catalyst slurry on the substrate; and
g2) placing the substrate in an oven with slowly increasing the temperature from 450□ to 500□ for 0.5 to 1 hour, and then cool down to produce the catalyst film.

21. The method according to claim 11, wherein the coating in step g) is carried out by doctor coating or dipping coating.

22. A method for producing catalyst used in wastewater treatment, which comprises the following steps:
a) preparing a solution containing a polymer and a hydroxylamine compound, wherein the polymer is a dispersing agent and stabilizer, and the hydroxylamine is reducing agent;
b) preparing a titanate solution with titante salts;
c) mixing the solution in step a) and the titanate solution in step b) to form a first mixture;
d) adding a thiol compound into the first mixture in step c) to form a second mixture, wherein the thiol is a complexing agent;
e) allowing the second mixture to react to form a first viscose catalyst slurry;
f) mixing the first viscose catalyst mixture and titania powder at a certain ratio to form a second catalyst slurry;
g) mixing the second catalyst slurry with at least one metal oxide to form a third catalyst slurry; and
h) coating the third catalyst slurry on a substrate and heating the slurry to form a catalyst film on the substrate.

23. The method according to claim 22, wherein the hydroxylamine compound is hydroxylamine hydrochloride or laurylamine hydrochloride (LAHC).

24. The method according to claim 22, wherein the titanate solution is comprising of titanate compound and acetylacetone.

25. The method according to claim 24, wherein the titanate compound is tetra-isopropyl titanate.

26. The method according to claim 22, wherein the step e) further comprises the following steps:
e1) treating the second mixture in a water bath to convert the second mixture into clear solution; and
e2) baking the clear solution to form the first viscose catalyst slurry.

27. The method according to claim 22, which further comprises a step of washing the catalyst slurry with organic solvent for several times after the step e).

28. The method according to claim 27, wherein the organic solvent is isopropanol.

29. The method according to claim 22, wherein the polymer is polyvinylpyrrolidone.

30. The method according to claim 22, wherein the heating in step h) is carried out by calcing the substrate at a temperature of from 450□ to 500□ for 0.5 to 1 hour to produce the catalyst film.

31. The method according to claim 22, wherein the coating in step g) is carried out by doctor coating or dipping coating.

32. The method according to claim 22, wherein the substrate is a conductive substrate.

33. The method according to claim 22, wherein the metal oxide is selected from Nb₂O₅, Ta₂O₅, and a combination thereof.

34. The method according to claim 22, wherein the certain ratio is a ratio that the first catalyst slurry is present in an amount of 30 to 90 wt. %.

35. The method according to claim 22, wherein the step d) is further added with a binder.

36. The method according to claim 35, wherein the binder is at least one selected from the group consisting of acetylacetone, polyethylene glycol having a molecular weight of from 400 to 50000, Triton X-100. polyvinyl alcohol (PVA), arabic gum, gelatin powder, polyvinylpyrrolidine and styrene.
